(19) United States
(12) Patent Application Publication
(10) Pub. No.: US 2011/0317136 A1
(43) Pub. Date: Dec. 29, 2011

(54) Inspection Apparatus Employing Wide Angle Objective Lens With Optical Window

(75) Inventors: Lev Ryzhikov, Norwalk, CT (US); Yuli Vladimirsky, Weston, CT (US); James H. Walsh, Newton, CT (US)

(73) Assignee: ASML Netherlands B.V., Veldhoven (NL)

(21) Appl. No.: 13/083,002

(22) Filed: Apr. 8, 2011

Related U.S. Application Data
(60) Provisional application No. 61/359,565, filed on Jun. 29, 2010.

(51) Int. Cl. G03B 27/52; G01N 21/47

(52) U.S. Cl. 355/30; 356/338

(57) ABSTRACT

An optical window is used to facilitate best performance for imaging an object placed in a separate ambiance. The window can be in a particle detection system, comprising a separator between first and second environments. The separator comprises an opening and an optical element located within the opening. An object is located in the second environment. An objective lens is located in the first environment and a detector is located in the second environment and is configured to detect particles on a surface of the object.

### CROSS REFERENCE TO RELATED APPLICATIONS

This application claims benefit under 35 U.S.C. §119(e) to U.S. Provisional Application No. 61/359,565, filed Jun. 29, 2010, which is incorporated by reference herein in its entirety.

### BACKGROUND

1. Field of the Invention

The present invention generally relates to lithography, and more particularly to an optical window separating environments configured to facilitate improved performance in the imaging of an object placed in one environment by a detector positioned in another environment.

2. Background Art

Lithography is widely recognized as a key process in manufacturing integrated circuits (ICs) as well as other devices and/or structures. A lithographic apparatus is a machine, used during lithography, which applies a desired pattern onto a substrate, such as onto a target portion of the substrate. During manufacture of ICs with a lithographic apparatus, a patterning device (which is alternatively referred to as a mask or a reticle) generates a circuit pattern to be formed on an individual layer in an IC. This pattern may be transferred onto the target portion (e.g., comprising part of, one, or several dies) on the substrate (e.g., a silicon wafer). Transfer of the pattern is typically via imaging onto a layer of radiation-sensitive material (e.g., resist) provided on the substrate. In general, a single substrate contains a network of adjacent target portions that are successively patterned. Manufacturing different layers of the IC often requires imaging different patterns on different layers with different reticles. Therefore, reticles must be changed during the lithographic process.

In some forms of lithography, the reticle along with other components and equipment needed to perform the lithography process, are kept in a vacuum environment. However, whenever possible, inspection equipment is placed external to the vacuum environment, for example, in an ambient environment.

In order to ensure good imaging quality, each reticle is examined for defects and/or particles. For example, before positioning a reticle onto a reticle support, an examination of an unpatterned side of the reticle will be performed. This is because any particles that are present on the unpatterned side of the reticle can cause errors in a patterned formed during exposure, e.g., the reticle to not be properly aligned or positioned in the reticle support. Misalignment of the reticle causes errors in the pattern transferred to a target substrate, which may reduce the quality and/or usability of the patterned substrate.

A window can be used in a inspection optical path when performing reticle particle inspection for separation of an objective lens in a normal environment (i.e., ambient air) from an aggressive or vacuum environment containing a sample to be imaged (i.e., inspected). For example, the reticle is positioned in the aggressive or vacuum environment, while the objective lens and detector are positioned outside the aggressive or vacuum environment in a second environment (e.g., ambient air). This window may be part of a reticle inspection chamber, which is different from the main lithographic exposure chamber. The window is typically comprised of plano-parallel plates of crown glass such as BK7, quartz, sapphire, etc.

The window material can be based on the windows functions for transmission and resistance to one or both of the environments that the window is separating. Therefore, the window is treated as a passive optical element. As such, it is often comprised of inexpensive, off-the-shelf material (e.g., BK7, quartz, sapphire, etc.). It is not uncommon for the off-the-shelf window to introduce spherical, coma, and/or astigmatism aberrations. This type of window often requires larger working distances to produce acceptable image qualities. The introduction of errors and larger working distances impede overall optimization of the imaging system.

### SUMMARY

Given the foregoing, what is needed is a corrective optical element in an optical inspection path. To meet this need, embodiments of the present invention are directed to a large field surface defect inspection apparatus employing wide angle objective lens with an optical window to facilitate best performance for imaging an object placed in separate ambience.

For example, an embodiment of the present invention provides a particle detection system comprising a separator, an optical element, an object, and objective lens, and a detector. The separator is located between first and second environments. The separator likewise comprises an opening. The optical element is located within the opening of the separator. The object is positioned in the second environment. The objective lens is positioned in first environment. The detector is also positioned in the first environment to detect, along an optical path passing through the objective lens and optical element, particles on a surface of the object.

In one example, the separator defines a wall of a reticle inspection chamber.

In one example, the optical element comprises a material configured to have a high refractive index and a low dispersion. The optical element is configured to correct at least spherical, coma, and astigmatism aberrations. In some examples, the optical element is configured to provide optical power in the optical path. In other examples, the optical element is configured to provide negligible optical power in the optical path. In at least one example, the optical element comprises two or more compositions of material each configured to exhibit a high refractive index and a low dispersion. In another example, at least one of the two or more compositions of material has a different refractive index value and a different dispersion value from the other compositions of material. In one example, the two or more compositions each comprise optical power.

In one example, the first environment is at approximately one atmosphere. In one example, the second environment is a vacuum.

In one example, the particle detection system comprises a detector to detect particles on the surface of an object based on a contrast level of scattered light from the surface of the object. In at least one example, the object is a reticle and the surface is an unpatterned side of the reticle.

According to another embodiment of the invention, there is provided a lithographic system comprising a reticle support, a projection system, a substrate support, and a reticle inspection chamber. The reticle support is configured to position a reticle in the path of the radiation beam so that the reticle produces a patterned beam. The projection system is configured to project the patterned beam onto a target portion of a substrate. The substrate support is configured to support the substrate during a lithographic process. The reticle inspection chamber is in communication with but removed from the location of the reticle support, the projection system, and the substrate support. The reticle inspection chamber comprises a wall, an optical element, an object, and objective lens, and a detector. The wall is located between first and second environments. The wall likewise comprises an opening. The optical element is located within the opening of the wall. The object is positioned in the second environment. The objective lens is positioned in first environment. The detector is also positioned in the first environment to detect, along an optical path passing through the objective lens and optical element, particles on a surface of the object.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIGS. 1A and 1B respectively depict reflective and transmissive lithographic apparatuses, which can be used to implement embodiments of the present invention.

FIG. 2 depicts an example EUV lithographic apparatus.

FIG. 3 depicts a particle detection system.

FIGS. 4, 5, 6, and 7 respectively depict different embodiments of optical elements that may serve as an optical window.

FIGS. 8 and 9 show first and second configurations of a particle detection system.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Overview

The present invention is directed to a defect inspection apparatus employing wide angle objective lens with optical window. This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Detailed below are embodiments of an optical element window for use in a wide angle inspection imaging system. In one embodiment, the optical element comprises a high refractive index and low dispersion material. In alternative embodiments, the optical element comprises two or more components, with or without optical power, which each are comprised of a high refractive index and low dispersion material. The optical element window is used to separate two different environments. Likewise, the optical element window is utilized as an active component (i.e., for aberration improvement and/or optical power) in an inspection imaging system.

Before describing such embodiments in more detail, however, it is instructive to present an example environment in which embodiments of the present invention may be implemented.

### II. An Example Lithographic Environment

A. Example Reflective and Transmissive Lithographic Systems

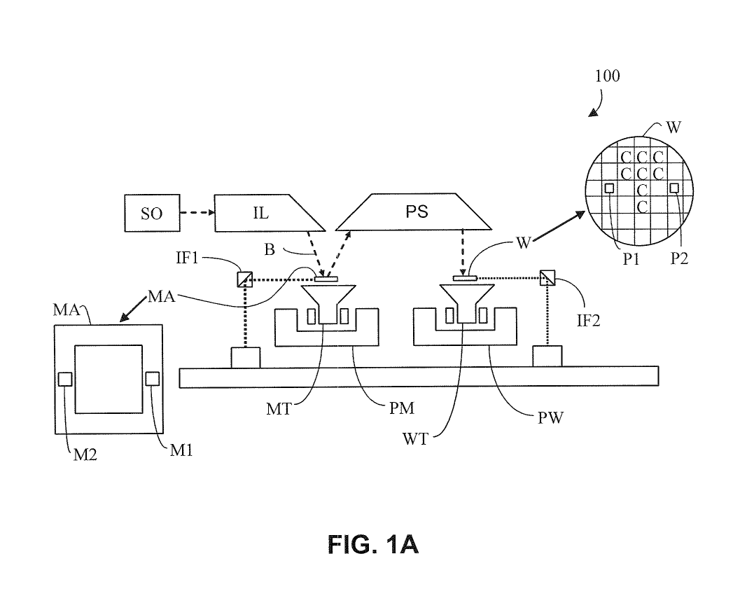

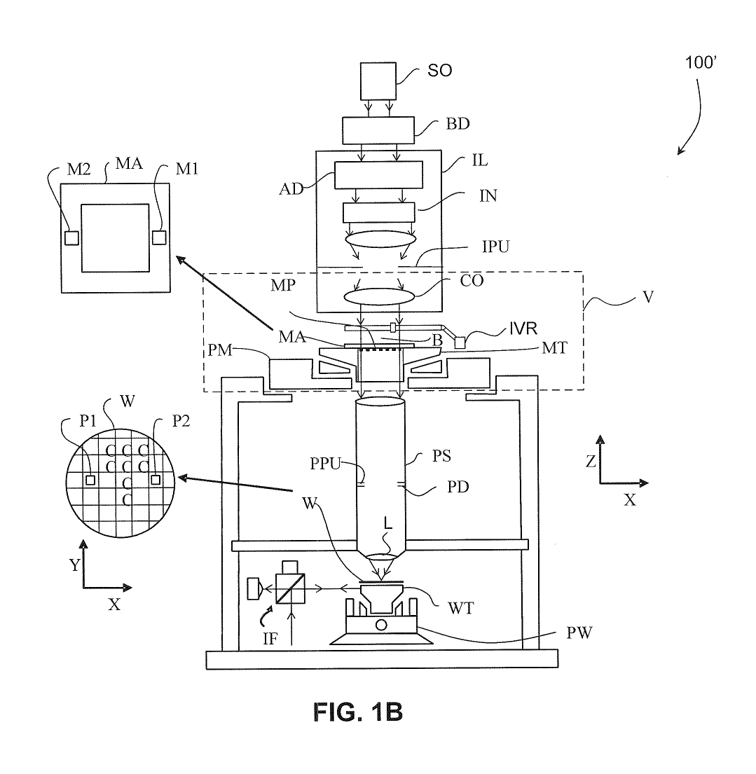

FIGS. 1A and 1B schematically depict lithographic apparatus 100 and lithographic apparatus 100′, respectively. Lithographic apparatus 100 and lithographic apparatus 100′ each include: an illumination system (illuminator) IL configured to condition a radiation beam B (e.g., DUV or EUV radiation); a support structure (e.g., a mask table) MT configured to support a patterning device (e.g., a mask, a reticle, or a dynamic patterning device) MA and connected to a first positioner PM configured to accurately position the patterning device MA; and a substrate table (e.g., a wafer table) WT configured to hold a substrate (e.g., a resist coated wafer) W and connected to a second positioner PW configured to accurately position the substrate W. Lithographic apparatuses 100 and 100′ also have a projection system PS configured to project a pattern imparted to the radiation beam B by patterning device MA onto a target portion (e.g., comprising one or more dies) C of the substrate W. In lithographic apparatus 100 the patterning device MA and the projection system PS is reflective, and in lithographic apparatus 100′ the patterning device MA and the projection system PS is transmissive.

The illumination system IL may include various types of optical components, such as refractive, reflective, magnetic, electromagnetic, electrostatic or other types of optical components, or any combination thereof, for directing, shaping, or controlling the radiation B.

The support structure MT holds the patterning device MA in a manner that depends on the orientation of the patterning device MA, the design of the lithographic apparatuses 100 and 100′, and other conditions, such as for example whether or not the patterning device MA is held in a vacuum environment. The support structure MT may use mechanical, vacuum, electrostatic or other clamping techniques to hold the patterning device MA. The support structure MT may be a frame or a table, for example, which may be fixed or movable, as required. The support structure MT may ensure that the patterning device is at a desired position, for example with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C, such as an integrated circuit.

The patterning device MA may be transmissive (as in lithographic apparatus 100′ of FIG. 1B) or reflective (as in lithographic apparatus 100 of FIG. 1A). Examples of patterning devices MA include reticles, masks, programmable mirror arrays, and programmable LCD panels. Masks are well known in lithography, and include mask types such as binary, alternating phase shift, and attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B which is reflected by the mirror matrix.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 and/or lithographic apparatus 100′ may be of a type having two (dual stage) or more substrate tables (and/or two or more mask tables) WT. In such “multiple stage” machines the additional substrate tables WT may be used in parallel, or preparatory steps may be carried out on one or more tables while one or more other substrate tables WT are being used for exposure.

Referring to FIGS. 1A and 1B, the illuminator IL receives a radiation beam from a radiation source SO. The source SO and the lithographic apparatuses 100, 100′ may be separate entities, for example when the source SO is an excimer laser. In such cases, the source SO is not considered to form part of the lithographic apparatuses 100 or 100′, and the radiation beam B passes from the source SO to the illuminator IL with the aid of a beam delivery system BD (FIG. 1B) comprising, for example, suitable directing mirrors and/or a beam expander. In other cases, the source SO may be an integral part of the lithographic apparatuses 100, 100′—for example when the source SO is a mercury lamp. The source SO and the illuminator IL, together with the beam delivery system BD, if required, may be referred to as a radiation system.

The illuminator IL may comprise an adjuster AD (FIG. 1B) for adjusting the angular intensity distribution of the radiation beam. Generally, at least the outer and/or inner radial extent (commonly referred to as σ-outer and σ-inner, respectively) of the intensity distribution in a pupil plane of the illuminator may be adjusted. In addition, the illuminator IL may comprise various other components (FIG. 1B), such as an integrator IN and a condenser CO. The illuminator IL may be used to condition the radiation beam B, to have a desired uniformity and intensity distribution in its cross section.

Referring to FIG. 1A, the radiation beam B is incident on the patterning device (e.g., mask) MA, which is held on the support structure (e.g., mask table) MT, and is patterned by the patterning device MA. In lithographic apparatus 100, the radiation beam B is reflected from the patterning device (e.g., mask) MA. After being reflected from the patterning device (e.g., mask) MA, the radiation beam B passes through the projection system PS, which focuses the radiation beam B onto a target portion C of the substrate W. With the aid of the second positioner PW and position sensor IF2 (e.g., an interferometric device, linear encoder or capacitive sensor), the substrate table WT may be moved accurately, e.g. so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

Referring to FIG. 1B, the radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1B) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (known as scribe-lane alignment marks). Similarly, in situations in which more than one die is provided on the mask MA, the mask alignment marks may be located between the dies.

The lithographic apparatuses 100 and 100′ may be used in at least one of the following modes:

1. In step mode, the support structure (e.g., mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.

2. In scan mode, the support structure (e.g., mask table) MT and the substrate table WT are scanned synchronously while a pattern imparted to the radiation beam B is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes programmable patterning device, such as a programmable mirror array of a type as referred to herein.

Combinations and/or variations on the described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

In a further embodiment, lithographic apparatus 100 includes an extreme ultraviolet (EUV) source, which is configured to generate a beam of EUV radiation for EUV lithography. In general, the EUV source is configured in a radiation system (see below), and a corresponding illumination system is configured to condition the EUV radiation beam of the EUV source.

B. Example EUV Lithographic Apparatus

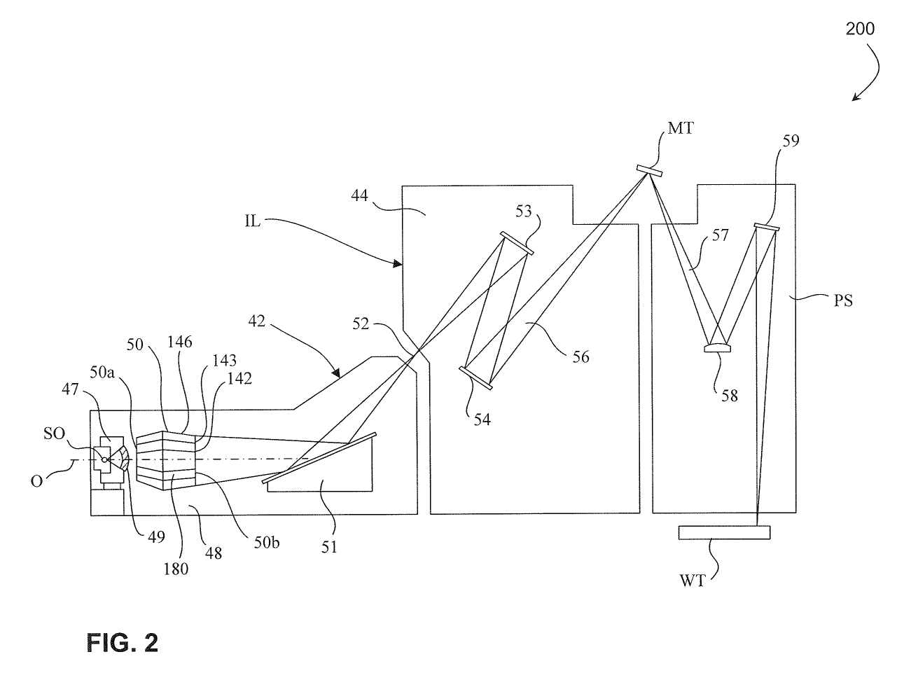

FIG. 2 schematically depicts an exemplary EUV lithographic apparatus 200 according to an embodiment of the present invention. In FIG. 2, EUV lithographic apparatus 200 includes a radiation system 42, an illumination optics unit 44, and a projection system PS. The radiation system 42 includes a radiation source SO, in which a beam of radiation may be formed by a discharge plasma. In an embodiment, EUV radiation may be produced by a gas or vapor, for example, from Xe gas, Li vapor, or Sn vapor, in which a very hot plasma is created to emit radiation in the EUV range of the electromagnetic spectrum. The very hot plasma can be created by generating at least partially ionized plasma by, for example, an electrical discharge. Partial pressures of, for example, 10 Pa of Xe, Li, Sn vapor or any other suitable gas or vapor may be required for efficient generation of the radiation. The radiation emitted by radiation source SO is passed from a source chamber 47 into a collector chamber 48 via a gas barrier or contaminant trap 49 positioned in or behind an opening in source chamber 47. In an embodiment, gas barrier 49 may include a channel structure.

Collector chamber 48 includes a radiation collector 50 (which may also be called collector mirror or collector) that may be formed from a grazing incidence collector. Radiation collector 50 has an upstream radiation collector side 50a and a downstream radiation collector side 50b, and radiation passed by collector 50 can be reflected off a grating spectral filter 51 to be focused at a virtual source point 52 at an aperture in the collector chamber 48. Radiation collectors 50 are known to skilled artisans.

From collector chamber 48, a beam of radiation 56 is reflected in illumination optics unit 44 via normal incidence reflectors 53 and 54 onto a reticle or mask (not shown) positioned on reticle or mask table MT. A patterned beam 57 is formed, which is imaged in projection system PS via reflective elements 58 and 59 onto a substrate (not shown) supported on wafer stage or substrate table WT. In various embodiments, illumination optics unit 44 and projection system PS may include more (or fewer) elements than depicted in FIG. 2. For example, grating spectral filter 51 may optionally be present, depending upon the type of lithographic apparatus. Further, in an embodiment, illumination optics unit 44 and projection system PS may include more mirrors than those depicted in FIG. 2. For example, projection system PS may incorporate one to four reflective elements in addition to reflective elements 58 and 59. In FIG. 2, reference number 180 indicates a space between two reflectors, e.g., a space between reflectors 142 and 143.

In an embodiment, collector mirror 50 may also include a normal incidence collector in place of or in addition to a grazing incidence mirror. Further, collector mirror 50, although described in reference to a nested collector with reflectors 142, 143, and 146, is herein further used as example of a collector.

Further, instead of a grating 51, as schematically depicted in FIG. 2, a transmissive optical filter may also be applied. Optical filters transmissive for EUV, as well as optical filters less transmissive for or even substantially absorbing UV radiation, are known to skilled artisans. Hence, the use of “grating spectral purity filter” is herein further indicated interchangeably as a “spectral purity filter,” which includes gratings or transmissive filters. Although not depicted in FIG. 2, EUV transmissive optical filters may be included as additional optical elements, for example, configured upstream of collector mirror 50 or optical EUV transmissive filters in illumination unit 44 and/or projection system PS.

The terms “upstream” and “downstream,” with respect to optical elements, indicate positions of one or more optical elements “optically upstream” and “optically downstream,” respectively, of one or more additional optical elements. Following the light path that a beam of radiation traverses through lithographic apparatus 200, a first optical elements closer to source SO than a second optical element is configured upstream of the second optical element; the second optical element is configured downstream of the first optical element. For example, collector mirror 50 is configured upstream of spectral filter 51, whereas optical element 53 is configured downstream of spectral filter 51.

All optical elements depicted in FIG. 2 (and additional optical elements not shown in the schematic drawing of this embodiment) may be vulnerable to deposition of contaminants produced by source SO, for example, Sn. Such may be the case for the radiation collector 50 and, if present, the spectral purity filter 51. Hence, a cleaning device may be employed to clean one or more of these optical elements, as well as a cleaning method may be applied to those optical elements, but also to normal incidence reflectors 53 and 54 and reflective elements 58 and 59 or other optical elements, for example additional mirrors, gratings, etc.

Radiation collector 50 can be a grazing incidence collector, and in such an embodiment, collector 50 is aligned along an optical axis O. The source SO, or an image thereof, may also be located along optical axis O. The radiation collector 50 may comprise reflectors 142, 143, and 146 (also known as a “shell” or a Wolter-type reflector including several Wolter-type reflectors). Reflectors 142, 143, and 146 may be nested and rotationally symmetric about optical axis O. In FIG. 2, an inner reflector is indicated by reference number 142, an intermediate reflector is indicated by reference number 143, and an outer reflector is indicated by reference number 146. The radiation collector 50 encloses a certain volume, i.e., a volume within the outer reflector(s) 146. Usually, the volume within outer reflector(s) 146 is circumferentially closed, although small openings may be present.

Reflectors 142, 143, and 146 respectively may include surfaces of which at least portion represents a reflective layer or a number of reflective layers. Hence, reflectors 142, 143, and 146 (or additional reflectors in the embodiments of radiation collectors having more than three reflectors or shells) are at least partly designed for reflecting and collecting EUV radiation from source SO, and at least part of reflectors 142, 143, and 146 may not be designed to reflect and collect EUV radiation. For example, at least part of the back side of the reflectors may not be designed to reflect and collect EUV radiation. On the surface of these reflective layers, there may in addition be a cap layer for protection or as optical filter provided on at least part of the surface of the reflective layers.

The radiation collector 50 may be placed in the vicinity of the source SO or an image of the source SO. Each reflector 142, 143, and 146 may comprise at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146, for example a protective holder, a heater, etc.

In the embodiments described herein, the terms “lens” and “lens element,” where the context allows, may refer to any one or combination of various types of optical components, comprising refractive, reflective, magnetic, electromagnetic and electrostatic optical components.

Further, the terms “radiation” and “beam” used herein encompass all types of electromagnetic radiation, comprising ultraviolet (UV) radiation (e.g., having a wavelength λ of 365, 248, 193, 157 or 126 nm), extreme ultra-violet (EUV or soft X-ray) radiation (e.g., having a wavelength in the range of 5-20 nm, e.g., 13.5 nm), or hard X-ray working at less than 5 nm, as well as particle beams, such as ion beams or electron beams. Generally, radiation having wavelengths between about 780-3000 nm (or larger) is considered IR radiation. UV refers to radiation with wavelengths of approximately 100-400 nm. Within lithography, it is usually also applied to the wavelengths, which can be produced by a mercury discharge lamp: G-line 436 nm; H-line 405 nm; and/or I-line 365 nm. Vacuum UV, or VUV (i.e., UV absorbed by air), refers to radiation having a wavelength of approximately 100-200 nm. Deep UV (DUV) generally refers to radiation having wavelengths ranging from 126 nm to 428 nm, and in an embodiment, an excimer laser can generate DUV radiation used within lithographic apparatus. It should be appreciated that radiation having a wavelength in the range of, for example, 5-20 nm relates to radiation with a certain wavelength band, of which at least part is in the range of 5-20 nm.

### III. Optical Window for a Wide Angle Lens Separating Two Environments

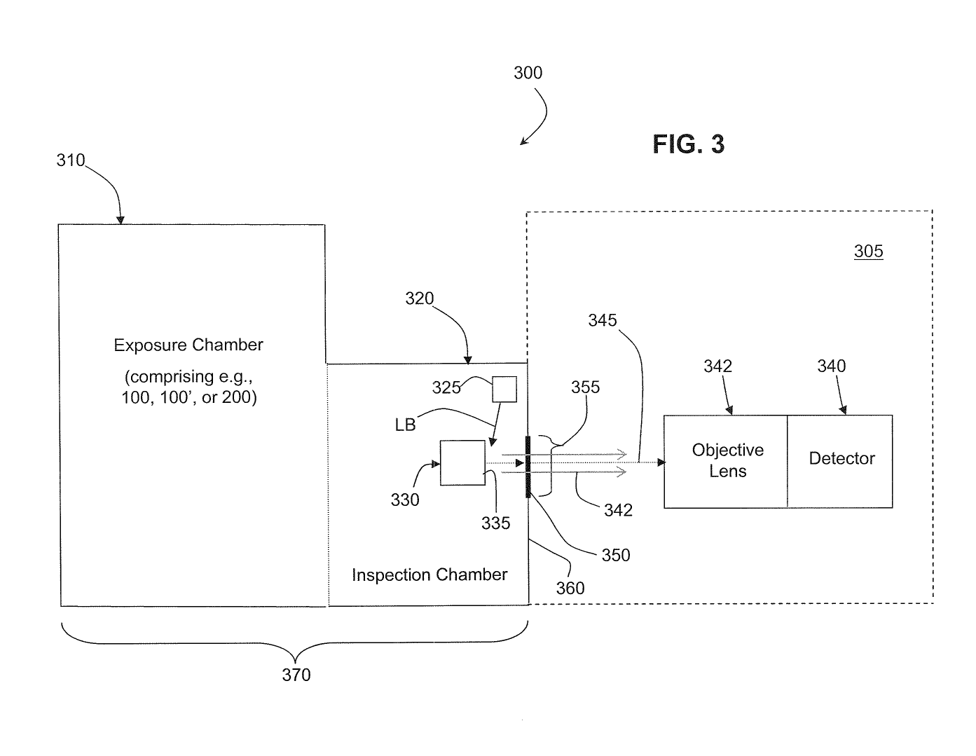

FIG. 3 schematically depicts a particle detection system 300 according to an embodiment of the present invention. For example, particle detection system 300 can be a reticle inspection system included in a lithographic apparatus having a first environment 305, such as those depicted FIG. 1A, 1B, or 2. In one example the particle inspection system 300 comprises a separator 360 between first and second environments 305/370. The separator 360 comprises an opening 355. An optical element 350 is located within the opening 355 of the separator 360. An object 330 is located in the second environment 370. An objective lens 342 is located in the first environment 305. A detector 340 is located in the first environment 305 and configured to detect, along an optical path 345 passing through the objective lens 342 and optical element 350, particles on a surface 335 of the object 330.

In the example shown, system 300 includes a first chamber 310, e.g., an exposure chamber, a second chamber 320, e.g., an inspection chamber (the first and second chambers 310/320 are within the second environment 370. Object 330 is positioned within the inspection chamber 320. Separator 360 is between second chamber 320 and a first environment 305.

In one example, the optical element window 350 is configured to pass light comprising an image of a surface of the object 330 to the detector 340 without introducing errors or aberrations to the image light. In at least one embodiment of the present invention, the object for inspection 330 is a reticle. In at least one embodiment, the inspection chamber 320 is configured to handle reticles.

In one example, before the object 330 is placed into operation in the exposure chamber 310, the object 330 is positioned in the inspection chamber 320. In the inspection chamber 320, a surface 335 of the object 330 is illuminated by a light beam LB (e.g., at an obtuse angle relative to the normal vector of the surface) from a light source 325.

In one example, the optical element window 350 can be configured such that a normal vector from a plane of the surface of the object 330 will pass through the optical element window 350 as a normal vector relative to the optical axis of the window 345. That is, in one example, the optical plane of the optical element window 350 is configured to be parallel to the surface plane of the object 330.

In one example, the surface of the object 330 is substantially smooth and shiny. In at least one example, the object 330 is a reticle, and the surface is the backside of the reticle. The backside of the reticle is unpatterned, shiny, and smooth. Therefore, when the surface of object 330 is illuminated with light beam LB, a majority of the light will reflect away from the surface 335 at an angle equal to an incident angle (i.e., source light ray).

The angles of incident and reflection are defined mathematically as relative to the normal vector of the surface. However, when the incident light LB illuminates particles or other unwanted structures on the surface 335, at least some of the light is scattered at an angle at or close to the normal vector (i.e., along an optical axis 345 of the optical element window 350). The detector 340 is configured to detect the incoming light rays 342 along the optical axis 345. Therefore, any particles are detected based on significant light contrast shifts between the particles and the smooth, shiny surface 335 of the object 330, because there is no light reflected along the optical path 345 from the surface 335 of the object 330 unless the light reflects from particles or other unwanted structures on the surface 335.

The composition of the optical element window 350 affects the quality of the contrast of the image from the surface 335 of the object 330. Thus, a chosen composition may cause the detector 340 to be unable to determine when particles or other unwanted structures are on the surface 335 of the object 330.

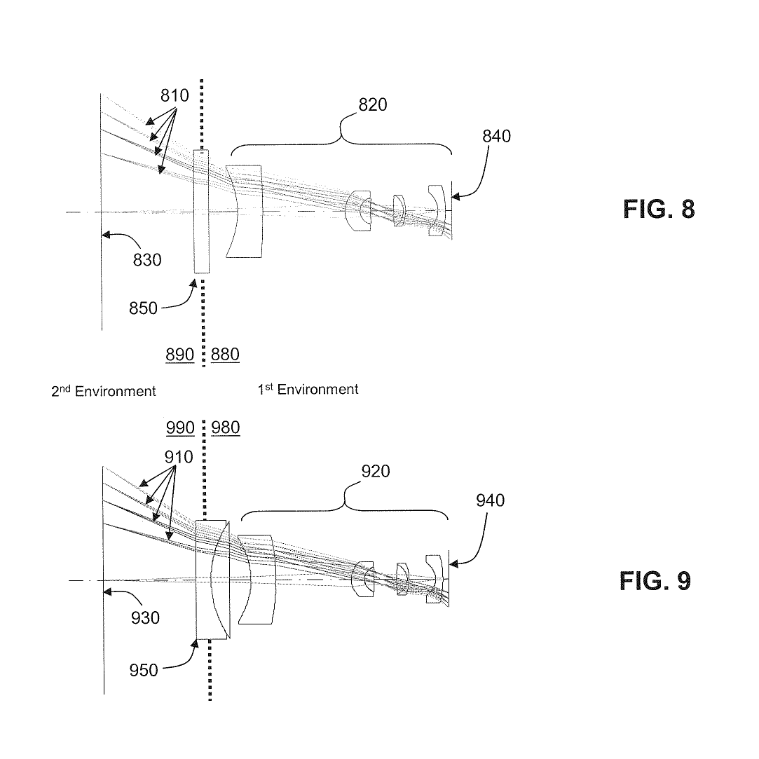

The detector 340 may also comprise additional objective lens elements (as seen in FIGS. 8 and 9). The additional lens elements are configured to allow a wide angle view of the surface 335 of the object 330.

In one example, if optical element window 350 is an inexpensive, off-the-shelf optics exhibiting less than optimal optical characteristics, errors can be introduced in the optical image of the surface 335 of the object 330. The errors may be, for example, spherical, coma, astigmatism aberrations, etc. In order to compensate for the errors, in one example, the size of the optical path 345 must be increased. Likewise, when the optical element window 350 introduces errors, optimization of optical path 345 is adversely affected. Therefore, the composition and design of the optical element window 350 is important.

Inspection of surface 335 of the object 330 is done to ensure that the entire lithographic exposure works optimally. For example, particles and other unwanted structures on the surface 335 of the object 330 may adversely affect positioning and setting of the object 330 into its associated support (not shown) in the lithographic apparatus (e.g., 100, 100′, or 200 in FIGS. 1A, 1B, and 2, respectively). In one example, particles on the backside of a reticle may adversely affect its positioning and alignment in a reticle support. Any misalignment caused by a particle on the backside of the reticle can result in substantial errors in a project pattern on a target substrate.

In one example, the window 350 is comprised of material(s) configured to have high refractive index and low dispersion for the detector 340 to obtain the best image possible through the optical element window 350. Additionally, or alternatively, other characteristics of the window 350 can also be chosen to obtain the best image possible.

Refractive index refers to a ratio of velocity of light in a vacuum to velocity of light through a substance. In one example, high refractive index can be about or above 1.75. As can be appreciated, refractive index of different materials is frequency dependent, such that materials that exhibit a refractive index lower than 1.75 for visible light, may exhibit a refractive index at or above 1.75 for ultraviolet light.

Dispersion refers to the phenomenon in which velocity of a wave through a material depends on the wave's frequency. In one example, an Abbe number can reflect dispersion, where the Abbe number is a measure of a material's dispersion in relation to the refractive index. In one example, low dispersion can be an Abbe number less than 30.

For example, by specifying that the optical element window 350 have a composition with high refractive index (n>1.75) and low dispersion (ν<34) glass such as optical glass offered by Schott catalog (N-SF4; N-SF6; N-SF66 etc.), the optical element window 350 becomes an active element in the optical path 345 and is able to effectively pass the light rays 342 reflected from the surface 335 the object 330 to the detector 340 without introducing aberrations into the image. In this example, the optical element window 350 exhibiting these characteristics allows for high quality imaging supporting a wider viewing angle and produces a high image contrast at the detector 340.

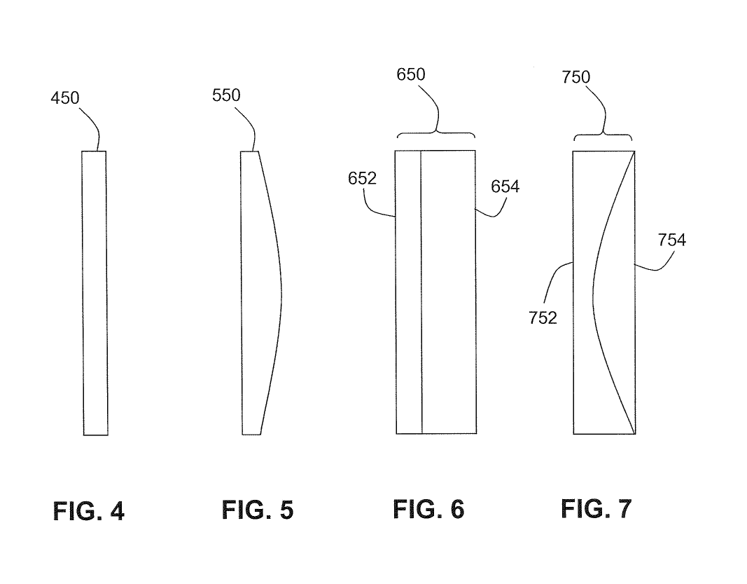

FIGS. 4, 5, 6, and 7 show four exemplary embodiments of optical elements 450, 550, 650, and 750 that can be used to implement window 350 in FIG. 3. It is to be appreciated that these examples are illustrative, but not exhaustive, examples.

FIG. 4 shows a plano-parallel plate 450 with substantially no optical power. In one example, as discussed above, the composition of the optical element 450 is controlled for high refractive index and low dispersion as discussed above.

FIG. 5 shows a plate 550 having optical power. Thus, in addition to refractive index and dispersion characteristics, plate 550 may also be used to introduce optical power along an optical path 345 of a particle detection system 300. In this exemplary configuration, an amount of optical power may be low.

FIG. 6 shows an optical element 650 having first and second coupled plano-parallel plates 652 and 654. In one example, there can be an air gap or other optical contact between the plates 652 and 654. It is to be appreciated more than two plates may also be used. In one example, plano-parallel plates 652 and 654 are comprised of material exhibiting both a high refractive index and low dispersion. In one example, plates 652 and 654 are comprised of material with different indexes of refraction, and different dispersions such as Schott optical glass N-LAF2 (n=1.743, ν=44.85) and N-SF4 (n=1.755; ν=27.38), providing better chromatic and monochromatic aberration correction such as coma, astigmatism, and axial chromatic aberration. For a pair of materials such as N-LAF36 (n=1.799, ν=42.37) and N-SF6 (n=1.805, ν=25.4) having similar indices of refraction, but different dispersions, only axial chromatic aberration can be corrected.

FIG. 7 shows an optical element 750 having first and second coupled optical components 752 and 754, each exhibiting some optical power, but combined produce very weak (or no) optical power. It is to be appreciated more than two components may also be used. Optical components 752 and 754 are comprised of material, exhibiting both a high refractive index and low dispersion e.g., the first window component can be made of Schott glass N-Laf7 (n=1.749, ν=34.8) and the second component can be made of N-SF4 (n=1.755, ν=27.38). In one example, components 752 and 754 can combine to produce an optical element window with no optical power. In some cases, when it is desirable, components 752 and 754 combine to produce an optical element window with optical power.

Additionally, or alternatively, components 652/654 and 752/754 may be brought into proximity or contact by an air gap, optical contact, and/or a medium, providing suitable optical properties, e.g. water, Canada balsam, synthetic coatings and materials, or the like.

FIGS. 8 and 9 show first and second configurations 800 and 900 of the optical path 345 of particle detection system 300.

In FIG. 8, configuration 800 comprises a surface 830 of an object (e.g., 330 in FIG. 3), wide angle light rays 810, a plano-parallel plate optical element window 850, a objective lens set 820, and a detection device 840. In at least one embodiment the surface 830 is the unpatterned side of reticle.

In FIG. 9, configuration 900 comprises a surface 930 of an object (e.g., 330 in FIG. 3), wide angle light rays 910, a multiple component (here two) optical element window 950, a objective lens set 520, and a detection device 540. In at least one embodiment the surface 530 is the unpatterned side of reticle.

In both FIGS. 8 and 9, the optical element windows 850/950 are positioned within a separator (e.g., 360 in FIG. 3) (i.e., wall, etc.). The separator (e.g., 360 in FIG. 3) is shown as a dotted line separating a first 880/980 and a second environment 890/990. Light rays 810/910 reflecting from particles on the surface 830/930 of an object (e.g., 330 in FIG. 3) are passed through the optical element 850/950 without introducing errors in the form of aberrations to the image. In FIG. 8 the image is unchanged, but in FIG. 9 the image is introduced to optical power in each of the two or more components of the optical element window 950. The light that passes through the optical element window 850/950 in either of FIG. 8 or 9, respectively, enters an objective lens set 820/920 that refracts/shapes the light onto a detection device 840/940. The objective lens set 820/920 in conjunction with the optical element window 850/950 is configured to capture a wide angle view of the surface 830/930 of an object (e.g., 330 in FIG. 3) without introducing unwanted aberrations and keeping the optical path 345 distance within reasonable ranges. This allows for imaging optimization to occur without being impeded by the optical element window 850/950 design. The detector 840/940 is configured to determine contrast shifts in the image thereby detecting the positions of unwanted particles on the surface 830/930 of the object (e.g., 330 in FIG. 3).

In summary, by designing an optical element window 350 (as shown in FIG. 3) with high refractive index and low dispersion as well as introducing the possibility of optical power in the optical element window 350, a designer can effectively produce a large field imagining system. Such a window 350 would be especially suitable for in-vacuum EUV reticle and wafer contamination inspection in terms of defects, particles, and haze. Although not specifically mentioned above, such a system would be applicable to inspection of reticle and wafer chucks for contamination. Likewise, the system would be equally applicable to both front and backside inspection of DUV and/or EUV reticles. Because of the large field of view provided by this system, full surface imaging can be performed without reticle scanning

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A particle detection system, comprising:
a separator between first and second environments, the separator comprising an opening;
an optical element located within the opening of the separator;
an object located in the second environment;
an objective lens located in the first environment; and
a detector located in the first environment configured to detect, along an optical path passing through the objective lens and optical element, particles on a surface of the object.

2. The particle detection system of claim 1, wherein the separator defines a wall of a reticle inspection chamber.

3. The particle detection system of claim 1, wherein the optical element comprises a material configured to have a high refractive index and a low dispersion.

4. The particle detection system of claim 1, wherein the optical element is configured to correct aberrations.

5. The particle detection system of claim 1, wherein the optical element is configured to provide optical power.

6. The particle detection system of claim 1, wherein the optical element comprises two or more compositions of material each configured to exhibit a high refractive index and a low dispersion.

7. The particle detection system of claim 6, wherein the two or more compositions of material have different values of the high refractive index and the low dispersion.

8. The particle detection system of claim 6, wherein the two or more compositions each comprise optical power.

9. The particle detection system of claim 1, wherein the optical element has negligible optical power.

10. The particle detection system of claim 1, wherein the first environment is at approximately 1 atmosphere.

11. The particle detection system of claim 1, wherein the second environment is a vacuum.

12. The particle detection system of claim 1, wherein the detector is configured to detect particles on the surface of the object based on a contrast level of scattered light from the surface of the object.

13. The particle detection system of claim 1, wherein the surface is on an unpatterned side of a reticle.

14. A lithographic system, comprising:
a reticle support configured to position a reticle in a path of a radiation beam so that the reticle produces a patterned beam;
a projection system configured to project the patterned beam onto a target portion of a substrate;
a substrate support configured to support the substrate during a lithographic process; and
a reticle inspection chamber in communication with but removed from the location of the reticle support, the projection system, and the substrate support, the reticle inspection chamber comprising:
a wall between first and second environments, the wall comprising an opening;
an optical element located within the opening;
an object located in the second environment;
an objective lens located in the first environment; and
a detector located in the first environment configured to detect, along an optical path passing through the objective lens and optical element, particles on a surface of the object.

15. The lithographic system of claim 14, wherein the optical element comprises a material with a high refractive index and a low dispersion.

16. The lithographic system of claim 14, wherein the optical element is configured to correct aberrations.

17. The lithographic system of claim 14, wherein the optical element is configured to provide optical power.

18. The lithographic system of claim 14, wherein the optical element comprises two or more compositions of material each configured to exhibit a high refractive index and a low dispersion, wherein the two or more compositions of material have different values of the high refractive index and the low dispersion.

19. The lithographic system of claim 14, wherein the first environment is at approximately 1 atmosphere and the second environment is a vacuum.

20. The lithographic system of claim 14, wherein the detector is configured to detect particles on the surface of the object based on a contrast level of scattered light from the surface of the object.
